(19) United States
(12) Patent Application Publication
(10) Pub. No.: US 2026/0346459 A1
(43) Pub. Date: Nov. 5, 2026

(54) METHOD AND DEVICE FOR OBTAINING POSITION COORDINATES OF COMPONENT AND EQUIPMENT ASSEMBLY SYSTEM

(71) Applicants: SQ TECHNOLOGY (SHANGHAI) CORPORATION, Shanghai (CN); INVENTEC CORPORATION, Taipei TW (CN)

(72) Inventors: Po-Jui Chen, Taipei TW (CN); Wei-Chao Chen, Taipei TW (CN); Hanjaya Mandala, Taipei TW (CN); Guilherme Christmann, Taipei TW (CN)

(21) Appl. No.: 19/291,658

(22) Filed: Aug. 6, 2025

(30) Foreign Application Priority Data
Mar. 5, 2025 (CN) 202510259213.4

(51) Int. Cl. B25J 9/16

(52) U.S. Cl. CPC B25J 9/1697; B25J 9/1664; B25J 9/1671; B25J 9/1687

(57) ABSTRACT

The present disclosure provides a method and a device for obtaining position coordinates of a component and an equipment assembly system. The method includes: obtaining a panoramic image corresponding to a component tray through a first camera device arranged at a predetermined position; inputting the panoramic image into a component recognition model to obtain a type and initial position coordinates of the component in the component tray; controlling a robotic arm to move to a target position according to the type and the initial position coordinates of the component, and then obtaining an overall image of the component through a second camera device provided on the robotic arm; and inputting the overall image of the component into a component positioning model to obtain final position coordinates of the component in the component tray.

### CROSS-REFERENCE TO RELATED APPLICATION

The present disclosure claims the priority to the Chinese patent application No. 202510259213.4 filed on Mar. 5, 2025 with the Chinese Patent Office and entitled “METHOD AND DEVICE FOR OBTAINING POSITION COORDINATES OF COMPONENT AND EQUIPMENT ASSEMBLY SYSTEM”, the contents of which are incorporated herein by reference in entirety.

### TECHNICAL FIELD

The present disclosure relates to the field of automated equipment assembly, and specifically to a method and a device for obtaining position coordinates of a component and an equipment assembly system.

### BACKGROUND ART

In the automated assembly process for the equipment, the position information of the component to be assembled is first identified. Then, based on the identified position information, a robotic arm is controlled to grasp the component and assemble the component onto the equipment.

In the prior art, most methods identify the position information of the component based on devices such as LiDAR and ultrasonic sensors. However, both LiDAR and ultrasonic sensors are susceptible to interference from environmental reflections, thereby reducing the accuracy for position information identification.

### SUMMARY

In a first aspect, the embodiments of the present disclosure provide a method for obtaining position coordinates of a component, and the method includes:
obtaining a panoramic image corresponding to a component tray through a first camera device arranged at a predetermined position, wherein a component to be assembled is placed in the component tray;
inputting the panoramic image into a component recognition model to obtain a type and initial position coordinates of the component in the component tray;
controlling a robotic arm to move to a target position according to the type and the initial position coordinates of the component, and then obtaining an overall image of the component through a second camera device provided on the robotic arm, wherein the overall image of the component includes the overall image of the component to be assembled; and
inputting the overall image of the component into a component positioning model to obtain final position coordinates of the component in the component tray.

In a second aspect, the embodiments of the present disclosure provide a device for obtaining position coordinates of a component, and the device includes:
an acquisition module, configured for obtaining a panoramic image corresponding to a component tray through a first camera device arranged at a predetermined position, wherein a component to be assembled is placed in the component tray; and
an input module, configured for inputting the panoramic image into a component recognition model to obtain a type and initial position coordinates of the component in the component tray, wherein
the acquisition module is further configured for controlling a robotic arm to move to a target position according to the type and the initial position coordinates of the component, and then obtaining an overall image of the component through a second camera device provided on the robotic arm, wherein the overall image of the component includes the overall image of the component to be assembled; and
the input module is further configured for inputting the overall image of the component into a component positioning model to obtain final position coordinates of the component in the component tray.

In a third aspect, the embodiments of the present disclosure further provide an electronic device, including: a processor, a storage medium, and a bus, wherein the storage medium stores machine-readable instructions executable by the processor. When the electronic device operates, the processor communicates with the storage medium via the bus, and the processor executes the machine-readable instructions to perform the steps of the method for obtaining position coordinates of a component as described in any one of the first aspect.

In a fourth aspect, the embodiments of the present disclosure further provide a computer-readable storage medium, wherein the computer readable storage medium stores a computer program. When the computer program is executed by the processor, it performs the steps of the method for obtaining position coordinates of a component as described in any one of the first aspect.

In a fifth aspect, the embodiments of the present disclosure further provide an equipment assembly system, wherein the system includes a controller, a robotic arm, a first camera device, a second camera device, and an assembly operation platform, wherein
the second camera device is mounted on an upper end of an end effector of the robotic arm; the assembly operation platform is configured for placing a component tray, and a component to be assembled is placed in the component tray;
the controller is configured to execute the method for obtaining position coordinates of a component as described in any one of the first aspect, to obtain the final position coordinates of the component in the component tray; and
the controller is further configured to control the robotic arm to assemble the component according to the final position coordinates.

### BRIEF DESCRIPTION OF DRAWINGS

To more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinary skilled in the art can also obtain other related drawings based on these drawings without inventive effort.

FIG. 1 illustrates a flowchart of a method for obtaining position coordinates of a component provided in an embodiment of the present disclosure;

FIG. 2 illustrates a flow diagram of controlling a movement of a robotic arm provided in an embodiment of the present disclosure;

FIG. 3 illustrates a flow diagram of model updating provided in an embodiment of the present disclosure;

FIG. 4 illustrates a structural diagram of a device for obtaining position coordinates of a component provided in an embodiment of the present disclosure;

FIG. 5 illustrates a structural schematic diagram of an electronic device provided in an embodiment of the present disclosure; and

FIG. 6 illustrates a structural schematic diagram of an equipment assembly system provided in an embodiment of the present disclosure.

### DETAILED DESCRIPTION OF EMBODIMENTS

To make the objectives, technical solutions, and advantages of the embodiments of the present disclosure clearer, the technical solutions in the embodiments of the present disclosure will be clearly and completely described below in conjunction with the drawings in the present disclosure. It should be understood that the drawings in the present disclosure are provided solely for illustrative and descriptive purposes and are not intended to limit the scope of protection of the present disclosure. In addition, it should be understood that the schematic drawings are not drawn to a physical scale. The flowcharts used in the present disclosure illustrate operations implemented according to some embodiments of the present disclosure. It should be understood that the operations of the flowchart can be implemented out of sequence, and steps without logical contextual relationships can be reversed in order or implemented simultaneously. Persons skilled in the art, guided by the contents of the present disclosure, may add one or more other operations to the flowchart and may remove one or more operations from the flowchart.

In addition, the described embodiments are only a part of the embodiments of the present disclosure, and not all of them. The components of embodiments of the present disclosure which are generally described and illustrated in the drawings herein can be arranged and designed in a variety of different configurations. Accordingly, the following detailed description of the embodiments of the present disclosure provided in the drawings is not intended to limit the scope of the present disclosure for which protection is claimed, but merely represents selected embodiments of the present disclosure. Based on the embodiments in the present disclosure, all other embodiments obtained of those of skill in the art of without making inventive efforts are within the scope of protection of the present disclosure.

To enable those skilled in the art to utilize the content of the present disclosure, the following embodiment is provided in connection with the specific application scenario of “the field of automated equipment assembly”. For those skilled in the art, the general principles defined herein can be applied to other embodiments and application scenarios without departing from the spirit and scope of the present disclosure. Although the present disclosure is primarily described around “the field of automated equipment assembly”, it should be understood that this is merely an exemplary embodiment.

It should be noted that the term “include” as used in the embodiments of the present disclosure can indicate the presence of the features stated thereafter but does not exclude the addition of other features.

In view of this, the objective of the present disclosure is to provide a method and a device for obtaining position coordinates of a component and an equipment assembly system, which can obtain the position coordinates of the component through the camera device, the component recognition model, and the component positioning model, thereby improving the accuracy of position recognition for the component.

In a first aspect, the embodiments of the present disclosure provide a method for obtaining position coordinates of a component, and the method includes:
obtaining a panoramic image corresponding to a component tray through a first camera device arranged at a predetermined position, wherein a component to be assembled is placed in the component tray;
inputting the panoramic image into a component recognition model to obtain a type and initial position coordinates of the component in the component tray;
controlling a robotic arm to move to a target position according to the type and the initial position coordinates of the component, and then obtaining an overall image of the component through a second camera device provided on the robotic arm, wherein the overall image of the component includes the overall image of the component to be assembled; and
inputting the overall image of the component into a component positioning model to obtain final position coordinates of the component in the component tray.

In one possible embodiment, the step of controlling a robotic arm to move to a target position according to the type and the initial position coordinates of the component, and then obtaining an overall image of the component through a second camera device provided on the robotic arm includes:
determining a shooting height of the second camera device according to the type of the component, wherein the second camera device is mounted on an upper end of an end effector of the robotic arm;
determining a movement path of the robotic arm according to the shooting height, the initial position coordinates, and current position coordinates of the robotic arm; and
controlling the robotic arm to move to the target position according to the movement path, and then obtaining the overall image of the component through the second camera device provided on the robotic arm.

In one possible embodiment, the step of determining a movement path of the robotic arm according to the shooting height, the initial position coordinates, and current position coordinates of the robotic arm includes:
determining a sum of a height coordinate value in the initial position coordinates and the shooting height as a target height;
modifying the height coordinate value in the current position coordinates of the robotic arm to the target height to obtain first movement position coordinates; modifying the height coordinate value in the initial position coordinates to the target height to obtain second movement position coordinates;
inputting the current position coordinates of the robotic arm as a starting point and the first movement position coordinates as an endpoint into a first path planning model to obtain a first movement path;
inputting the first movement position coordinates of the robotic arm as the starting point and the second movement position coordinates as the endpoint into the first path planning model to obtain a second movement path; and
connecting the first movement path and the second movement path to obtain the movement path of the robotic arm.

In one possible embodiment, the step of determining a movement path of the robotic arm according to the shooting height, the initial position coordinates, and current position coordinates of the robotic arm further includes:
inputting the shooting height, the initial position coordinates, and the current position coordinates of the robotic arm into a second path planning model to obtain the movement path of the robotic arm, wherein the starting point of the movement path is the current position coordinates of the robotic arm, a sum of the height coordinate value in the initial position coordinates and the shooting height is the height coordinate value of the endpoint in the movement path, and a distance between the endpoint in the movement path and a position corresponding to the initial position coordinates is less than a preset distance.

In one possible embodiment, the method further includes:
controlling the robotic arm to move to the final position coordinates and grasp the component;
controlling the robotic arm to move according to preset assembly position coordinates corresponding to the component until the current position coordinates of the robotic arm and the preset assembly position coordinates meet a preset numerical relationship condition, and rotating the second camera device according to a preset assembly shooting angle corresponding to the type of the component;
obtaining an assembly scene image through the rotated second camera device, wherein the assembly scene image includes a position scene corresponding to the preset assembly position coordinates; and
controlling the robotic arm to assemble the component according to the assembly scene image and the preset assembly position coordinates.

In one possible embodiment, the component recognition model is trained through the following steps:
obtaining a panoramic sample image corresponding to the component tray, and position coordinates and a type corresponding to a first component sample in the component tray;
using the panoramic sample image as a sample, and using the position coordinates and the type corresponding to the first component sample as labels to perform model training on the component recognition model.

In one possible embodiment, the method further includes:
calculating a difference between final position coordinates and the initial position coordinates of the component;
using, when the difference meets a preset difference condition, the panoramic image as sample data and using the final position coordinates and actual type of the component as the labels corresponding to the panoramic image, and correspondingly adding them to a sample dataset; and
updating the component recognition model based on the sample data in the sample dataset and the corresponding labels, when a number of sample data in the sample dataset is greater than a preset number, or when a non-updated duration corresponding to the component recognition model is greater than a preset update duration.

In one possible embodiment, the component positioning model is trained through the following steps:
obtaining an overall sample image of the component and the position coordinates corresponding to a second component sample in the overall sample image of the component; and
using the overall sample image of the component as a sample, and using the position coordinates corresponding to the second component sample as labels to perform model training on the component positioning model.

In a second aspect, the embodiments of the present disclosure provide a device for obtaining position coordinates of a component, and the device includes:
an acquisition module, configured for obtaining a panoramic image corresponding to a component tray through a first camera device arranged at a predetermined position, wherein a component to be assembled is placed in the component tray; and
an input module, configured for inputting the panoramic image into a component recognition model to obtain a type and initial position coordinates of the component in the component tray, wherein
the acquisition module is further configured for controlling a robotic arm to move to a target position according to the type and the initial position coordinates of the component, and then obtaining an overall image of the component through a second camera device provided on the robotic arm, wherein the overall image of the component includes the overall image of the component to be assembled; and
the input module is further configured for inputting the overall image of the component into a component positioning model to obtain final position coordinates of the component in the component tray.

In a third aspect, the embodiments of the present disclosure further provide an electronic device, including: a processor, a storage medium, and a bus, wherein the storage medium stores machine-readable instructions executable by the processor. When the electronic device operates, the processor communicates with the storage medium via the bus, and the processor executes the machine-readable instructions to perform the steps of the method for obtaining position coordinates of a component as described in any one of the first aspect.

In a fourth aspect, the embodiments of the present disclosure further provide a computer-readable storage medium, wherein the computer readable storage medium stores a computer program. When the computer program is executed by the processor, it performs the steps of the method for obtaining position coordinates of a component as described in any one of the first aspect.

In a fifth aspect, the embodiments of the present disclosure further provide an equipment assembly system, wherein the system includes a controller, a robotic arm, a first camera device, a second camera device, and an assembly operation platform, wherein
the second camera device is mounted on an upper end of an end effector of the robotic arm; the assembly operation platform is configured for placing a component tray, and a component to be assembled is placed in the component tray;
the controller is configured to execute the method for obtaining position coordinates of a component as described in any one of the first aspect, to obtain the final position coordinates of the component in the component tray; and
the controller is further configured to control the robotic arm to assemble the component according to the final position coordinates.

The embodiments of the present disclosure provide a method and a device for obtaining position coordinates of a component and an equipment assembly system. The method includes: obtaining a panoramic image corresponding to a component tray through a first camera device arranged at a predetermined position; inputting the panoramic image into a component recognition model to obtain a type and initial position coordinates of the component in the component tray; controlling a robotic arm to move to a target position according to the type and the initial position coordinates of the component, and then obtaining an overall image of the component through a second camera device provided on the robotic arm; and inputting the overall image of the component into a component positioning model to obtain final position coordinates of the component in the component tray. The present disclosure obtains the position coordinates of the component through the camera device, the component recognition model, and the component positioning model, thereby improving the accuracy of position recognition for the component.

A method for obtaining position coordinates of a component provided in an embodiment of the present disclosure is described in detail below.

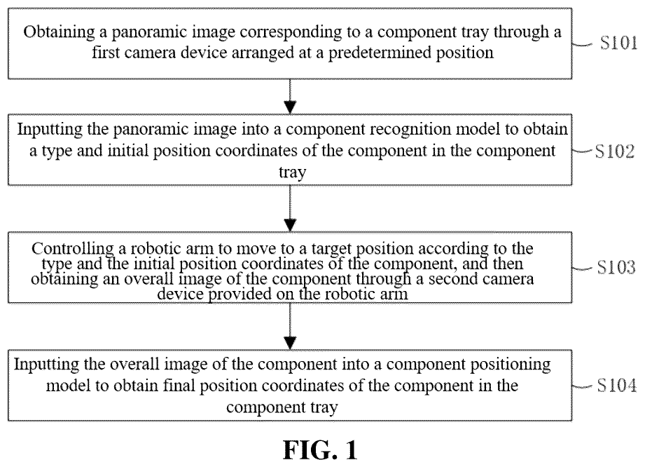

Referring to FIG. 1, FIG. 1 illustrates a flowchart of a method for obtaining position coordinates of a component provided in an embodiment of the present disclosure. The following is a description of each exemplary step of the embodiment of the present disclosure.

S101: obtaining a panoramic image corresponding to a component tray through a first camera device arranged at a predetermined position, wherein a component to be assembled is placed in the component tray.

In the embodiments of the present disclosure, the panoramic image includes the entire region of the component tray and is used to identify the type and initial position coordinates of the component in the component tray. The predetermined position refers to a fixed position of the first camera device that is preset in advance and is capable of capturing the entire region of the component tray. The component to be assembled refers to a part or module of the current assembly equipment, which can be a server. When a component to be assembled is present in the component tray, the panoramic image corresponding to the component tray, captured by the first camera device, is obtained through a data transmission device such as USB. The component to be assembled is placed in the component tray.

S102: inputting the panoramic image into a component recognition model to obtain a type and initial position coordinates of the component in the component tray.

In the embodiments of the present disclosure, the component recognition model is configured to obtain the type and initial position coordinates of the component in the component tray. The component recognition model can be trained in advance using the panoramic sample image corresponding to the component tray, the position coordinates and the type corresponding to a first component sample in the component tray. The component recognition model can also be trained in advance using the panoramic sample image corresponding to the component tray, the position coordinates, the type, and the angle of the first component sample in the component tray. The angle refers to the placement angle of the first component sample in the component tray. That is, the input of the component recognition model is the panoramic image corresponding to the component tray. The output of the component recognition model can be the type and initial position coordinates of the component in the component tray. The output of the component recognition model can also include the initial position coordinates, type, and angle of the component in the component tray.

The type of the component can include the name, identification number, and other identifiers of the component. The component recognition model can be a deep learning model such as YOLOv8 or CNN.

In addition, when the output of the component recognition model is the type and initial position coordinates of the component in the component tray, the component recognition model is trained by the following steps.

Step one: obtaining a panoramic sample image corresponding to the component tray, and position coordinates and a type corresponding to a first component sample in the component tray.

In the embodiments of the present disclosure, the panoramic sample image includes the entire region of the component tray and is used to train the component recognition model. The first component sample in the component tray refers to a component inside the component tray in the panoramic sample image and is configured to train the component recognition model. The position coordinates corresponding to the first component sample can be manually annotated. The type corresponding to the first component sample is the same as the aforementioned component type.

Step two: using the panoramic sample image as a sample, and using the position coordinates and the type corresponding to the first component sample as labels to perform model training on the component recognition model.

In the embodiments of the present disclosure, the panoramic sample image is input into the component recognition model to obtain the predicted position coordinates and predicted type corresponding to the first component sample. The component recognition model is trained based on the position coordinates and type corresponding to the first component sample and the predicted position coordinates and predicted type corresponding to the first component sample.

In addition, when the output of the component recognition model is the initial position coordinates, the type, and the angle of the component in the component tray, the component recognition model is trained by the following steps.

Step one: obtaining a panoramic sample image corresponding to the component tray; and the position coordinates, the type, and the angle of a first component sample in the component tray.

In the embodiments of the present disclosure, the panoramic sample image includes the entire region of the component tray and is used to train the component recognition model. The first component sample in the component tray refers to a component inside the component tray in the panoramic sample image and is configured to train the component recognition model. The position coordinates and angles corresponding to the first component sample can be manually annotated. The type corresponding to the first component sample is the same as the aforementioned component type.

Step two: using the panoramic sample image as a sample, and using the position coordinates, the type, and the angle corresponding to the first component sample as labels to perform model training on the component recognition model.

In the embodiments of the present disclosure, the panoramic sample image is input into the component recognition model to obtain the predicted position coordinates, the predicted type, and the predicted angle corresponding to the first component sample. The component recognition model is trained based on the position coordinates, the type, and the angle corresponding to the first component sample, and based on the predicted position coordinates, the predicted type, and the predicted angle corresponding to the first component sample.

Further, the method includes: adjusting the posture of the robotic arm according to the angle of the component to enable the robotic arm to smoothly grasp the component.

In the present disclosure, the initial position coordinates of the component are taken as the center point, which ensures that the robotic arm can subsequently grasp the component smoothly and assemble it by using the “center point +angle” approach.

S103: controlling a robotic arm to move to a target position according to the type and the initial position coordinates of the component, and then obtaining an overall image of the component through a second camera device provided on the robotic arm, wherein the overall image of the component includes the overall image of the component to be assembled.

In the embodiments of the present disclosure, the target position refers to the lowest position in height that allows capturing the overall image of the component. The absolute value of the difference between the height coordinate value of the target position and the height coordinate value of the component corresponds to the shooting height. The shooting height is preset based on the size of the component. Different types of components correspond to different target positions.

Specifically, the step of controlling a robotic arm to move to a target position according to the type and the initial position coordinates of the component, and then obtaining an overall image of the component through a second camera device provided on the robotic arm includes the following step.

Step one: determining a shooting height of the second camera device according to the type of the component, wherein the second camera device is mounted on an upper end of an end effector (e.g., a gripper) of the robotic arm.

In the embodiments of the present disclosure, the shooting height corresponding to the type of the component is queried in a preset shooting height table, and the queried shooting height is determined as the shooting height of the second camera device. The shooting height table stores correspondingly, in a preset manner, the type of the component and the shooting height of the component.

The shooting height table can also store the size of the component. The shooting heights for new components can be added to the shooting height table through the following steps, specifically: obtaining the type of the component to be added and the size of the component; determining the shooting height of the component to be added based on the shooting heights of all components in the shooting height table that have the same size as the component to be added.

Further, the step of determining the shooting height of the component to be added based on the shooting heights of all components in the shooting height table that have the same size as the component to be added includes: determining the average value of the shooting heights of all components in the shooting height table that have the same size as the component to be added as the shooting height of the component to be added; or determining the mode of the shooting heights of all components in the shooting height table that have the same size as the component to be added as the shooting height of the component to be added.

For example, components in the shooting height table that have the same size as the component to be added include component A, component B, component C, and component D. The shooting height of component A is 4 cm, the shooting height of component B is 4 cm, the shooting height of component C is 3 cm, and the shooting height of component D is 2 cm. The shooting height of the component to be added can be (4+4+3+2)/4=3.25 cm (i.e., determining the average value of the shooting heights of all components in the shooting height table that have the same size as the component to be added as the shooting height of the component to be added), or it can be 4 cm (i.e., determining the mode of the shooting heights of all components in the shooting height table that have the same size as the component to be added as the shooting height of the component to be added).

Step two: determining a movement path of the robotic arm according to the shooting height, the initial position coordinates, and current position coordinates of the robotic arm.

In the embodiments of the present disclosure, the endpoint in the movement path is the target position. The embodiments of the present disclosure provide two methods for determining the movement path of the robotic arm.

The specific steps of the first method are as follows.

Step i: determining a sum of a height coordinate value in the initial position coordinates and the shooting height as a target height.

For example, the initial position coordinate is (2, 3, 6), and the shooting height is 2, so the target height is 6+2=8.

Step ii: modifying the height coordinate value in the current position coordinates of the robotic arm to the target height to obtain first movement position coordinates.

In the embodiments of the present disclosure, the current position coordinate of the end effector of the robotic arm is used as the current position coordinate of the robotic arm.

For example, if the target height is 8, and if the current position coordinate of the robotic arm is (3, 4, 2), then, the height coordinate value in the current position coordinates of the robotic arm is modified to the target height to obtain first movement position coordinates (3, 4, 8).

Step iii: modifying the height coordinate value in the initial position coordinates to the shooting height to obtain second movement position coordinates.

For example, if the target height is 8 and the initial position coordinate is (2, 3, 6), then the height coordinate value in the initial position coordinates is modified to the shooting height to obtain second movement position coordinates (2, 3, 8).

Step iv: inputting the current position coordinates of the robotic arm as a starting point and the first movement position coordinates as an endpoint into a first path planning model to obtain a first movement path.

In the embodiments of the present disclosure, the current position coordinate of the robotic arm is used as the starting point, and the first movement position coordinate is used as the endpoint and input into the first path planning model to predict possible situations, so as to generate an optimal first movement path.

Step v: inputting the first movement position coordinates of the robotic arm as the starting point and the second movement position coordinates as the endpoint into the first path planning model to obtain a second movement path.

In the embodiments of the present disclosure, the first movement position coordinate of the robotic arm is used as the starting point, and the second movement position coordinate is used as the endpoint and input into the first path planning model to predict possible situations, so as to generate an optimal second movement path.

Step vi: connecting the first movement path and the second movement path to obtain the movement path of the robotic arm.

In the embodiments of the present disclosure, the endpoint of the first movement path is the starting point of the second movement path. Therefore, the first movement path and the second movement path are connected via the first movement position to obtain the movement path of the robotic arm.

The specific steps of the second method include: inputting the shooting height, the initial position coordinates, and the current position coordinates of the robotic arm into a second path planning model to obtain the movement path of the robotic arm, wherein the starting point of the movement path is the current position coordinates of the robotic arm, a sum of the height coordinate value in the initial position coordinates and the shooting height is the height coordinate value of the endpoint in the movement path, and a distance between the endpoint in the movement path and a position corresponding to the initial position coordinates is less than a preset distance.

Both the first path planning model and the second path planning model are trained by taking whether the movement path has a collision and the movement duration as rewards.

Step three: controlling a robotic arm to move to a target position according to the movement path, and then obtaining the overall image of the component through the second camera device provided on the robotic arm.

In the embodiments of the present disclosure, the monitoring data of the robotic arm during the movement process is instantly read through sensors (such as cameras, and LiDAR) to monitor the state of the robotic arm and environmental information, thus ensuring smooth movement. If an abnormal situation occurs during movement, after resolving the abnormality, updates are made to the first path planning model.

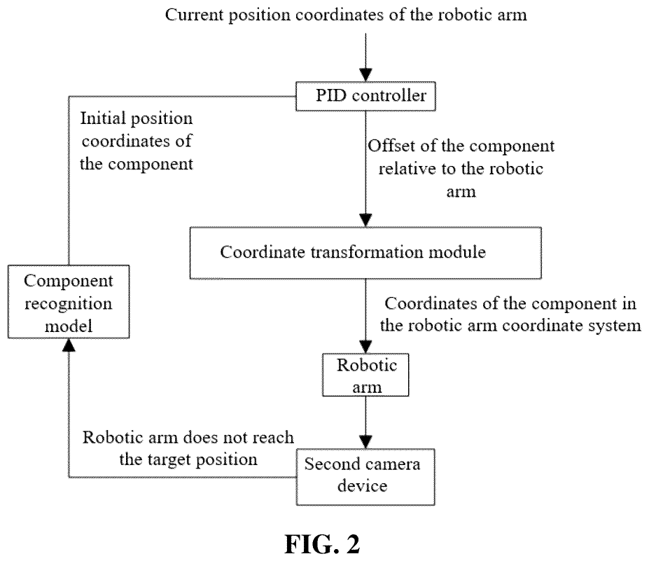

Additionally, the present disclosure provides another method for controlling the robotic arm to move to the target position based on the type and initial position coordinate of the component. Referring to FIG. 2, FIG. 2 illustrates a flow diagram of controlling a movement of a robotic arm provided in an embodiment of the present disclosure. The initial position coordinate of the component is obtained based on the component recognition model. A PID (proportional-integral-derivative) controller calculates the offset of the component relative to the robotic arm based on the initial position coordinate and the current position coordinate of the robotic arm. The coordinate transformation module determines the coordinate of the component in the robotic arm coordinate system based on the offset and the current position coordinate of the robotic arm. The movement direction of the robotic arm is controlled based on the transformed coordinate. Meanwhile, the image in front of the robotic arm, captured by the second camera device during movement, is used to determine whether the target position is reached. If the target position is not reached, the initial position coordinate of the component continues to be obtained based on the component recognition model to further control the robotic arm.

It should be noted that the following algorithms are used in the control process of the robotic arm: (1) tracking control, closed-loop control, and feedback control; (2) visual servoing—closed-loop control; (3) AI target detection with angle detection; and (4) target detection and angle detection.

S104: inputting the overall image of the component into a component positioning model to obtain final position coordinates of the component in the component tray.

In the embodiments of the present disclosure, the component positioning model is configured to determine the final position coordinates of the component in the component tray. The component positioning model is trained in advance using the overall sample image of the component, and the position coordinates corresponding to the second component sample in the overall sample image of the component.

The component positioning model can be a deep learning model such as YOLOv8 or CNN.

The first camera device, the second camera device, the component recognition model, and the component positioning model are used to locate the components in the component tray, achieving real-time locking, dynamic correction, and tracking. Compared to the traditional technology where the component position is fixed, the method of the present disclosure offers strong adaptability and greater flexibility, and eliminates the concept of blind insertion in traditional positioning, thereby significantly improving the efficiency of the line changeover. By using the fundamental movement with optical feedback, the system learns spatial concepts to achieve intelligent initialization, thereby greatly reducing deployment time. In the field of precision operations in industrial automation, precise grasping and positioning of target objects are often required, making the determination of an appropriate reference point particularly critical. Compared to traditional positioning methods that rely on an absolute zero point, the present disclosure adopts a center point with unique advantages. The center point is not a conventional zero point but a grasping zero point determined based on optical technology. Compared with traditional zero-point positioning, the optical grasping zero point does not require complex mechanical calibration to determine the absolute zero position, thereby significantly reducing time costs for equipment debugging and maintenance.

In addition, the component positioning model is trained through following steps.

Step one: obtaining an overall sample image of the component and the position coordinates corresponding to a second component sample in the overall sample image of the component.

In the embodiments of the present disclosure, the overall sample image of the component includes the entire region of the second component sample, which is used to train the component positioning model. The second component sample is configured to train the component positioning model. The position coordinates corresponding to the second component sample can be manually annotated.

Step two: using the overall sample image of the component as a sample, and using the position coordinates corresponding to the second component sample as labels to perform model training on the component positioning model.

In the embodiments of the present disclosure, the overall sample image of the component is input into the component positioning model to obtain the predicted position coordinates corresponding to the second component sample. The component positioning model is trained based on the position coordinates corresponding to the second component sample, and based on the predicted position coordinates corresponding to the second component sample.

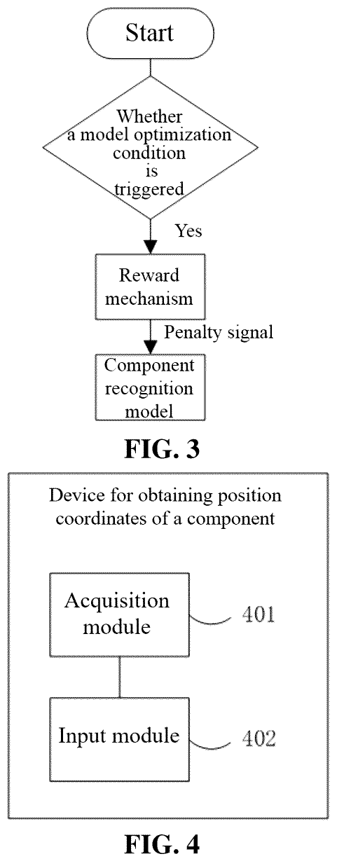

Furthermore, referring to FIG. 3, which illustrates the flow diagram of model updating provided in the embodiment of the present disclosure, multiple model optimization conditions are preset in advance. During the application process of the component recognition model, when a preset model optimization condition is triggered, the reward mechanism feeds a penalty signal back to the component recognition model. Upon receiving the penalty signal, the component recognition model performs model updating based on the sample data in the sample dataset and the corresponding labels.

The model optimization conditions can include: (1) the customer feeds back the failure of component assembly; (2) the time required to determine the initial position coordinate of the component exceeds a preset threshold; (3) failure to recognize the component; (4) the number of sample data in the sample dataset exceeds a preset number; and (5) the non-updated duration corresponding to the component recognition model exceeds a preset update duration.

The embodiments of the present disclosure utilize the prediction results of the component positioning model to update the component recognition model. Specifically, the following steps are included.

Step one: calculating a difference between final position coordinates and the initial position coordinates of the component.

In the embodiments of the present disclosure, the step includes calculating, for each coordinate axis, the absolute value of the difference between the coordinate value of the coordinate axis in the final position coordinates of the component and the coordinate value of the coordinate axis in the initial position coordinates of the component, and obtaining the corresponding difference of the coordinate axis; taking the sum of the differences corresponding to all coordinate axes as the difference between the final position coordinates and the initial position coordinates of the component; or taking the weighted sum of the differences corresponding to all coordinate axes as the difference between the final position coordinates and the initial position coordinates of the component.

Step two: using, when the difference meets a preset difference condition, the panoramic image as sample data and using the final position coordinates and actual type of the component as the labels corresponding to the panoramic image, and correspondingly adding them to a sample dataset.

In the embodiment of the present disclosure, the larger the difference is, the more inaccurate the prediction result of the component positioning model is. The preset difference condition can be that the difference is greater than or equal to a preset difference, and if the difference is greater than or equal to the preset difference, the panoramic image is used as the sample data, and the final position coordinates and actual type of the component are used as the labels corresponding to the panoramic image, which are then correspondingly added to the sample dataset.

By the method of the present disclosure, image resources from actual applications can be added to the sample dataset to update the component recognition model.

Step three: updating the component recognition model based on the sample data in the sample dataset and the corresponding labels, when a number of sample data in the sample dataset is greater than a preset number, or when a non-updated duration corresponding to the component recognition model is greater than a preset update duration.

In the embodiment of the present disclosure, the non-updated duration refers to the duration between the current time and the last update time of the component recognition model.

During model updating, the offset designed for the component recognition model can be adjusted to improve the accuracy of the model.

Furthermore, in the embodiments of the present disclosure, the robotic arm is also controlled to assemble the components based on the final position coordinates, specifically including the following steps.

Step one: controlling the robotic arm to move to the final position coordinates and grasp the component.

Step two: controlling the robotic arm to move according to preset assembly position coordinates corresponding to the component until the current position coordinates of the robotic arm and the preset assembly position coordinates meet a preset numerical relationship condition, and rotating the second camera device according to a preset assembly shooting angle corresponding to the type of the component.

In the embodiment of the present disclosure, the preset assembly position refers to the preset position of the assembled component, where the component corresponds one-to-one with the preset assembly position coordinates. The preset numerical relationship condition can be that the distance difference between the current position coordinates of the robotic arm and the preset assembly position coordinates is smaller than a preset distance. When the distance difference between the current position coordinates of the robotic arm and the preset assembly position coordinates is smaller than the preset distance, the second camera device is rotated according to the preset assembly shooting angle corresponding to the type of the component, so that the second camera device can capture the assembly scene image.

In contrast to the one-to-one correspondence between the components and the preset assembly position coordinates, the component tray configured to hold the components is in a freely arranged state. This is because the flexibility of the component tray placement is considered in the design of the entire production process. Through this method, even if the placement position of the component tray is not fixed, the components within it can be quickly and accurately gripped.

The preset assembly shooting angle corresponding to the type of component is determined based on the assembly direction of the component (such as from top to down, and from left to right).

Step three: obtaining an assembly scene image through the rotated second camera device, wherein the assembly scene image includes a position scene corresponding to the preset assembly position coordinates.

Step four: controlling the robotic arm to assemble the component according to the assembly scene image and the preset assembly position coordinates.

Additionally, the deep learning model involved in the present disclosure can be fed back to the data center and shared with other robotic arms to share resources. Through this parallel replication of multi-agent learning, iteration becomes easier, and the deployment scope can be expanded.

In the present disclosure, it only needs to define the preset assembly position of the component to guide the movement path of the robotic arm after grabbing the component. Through thousands of reinforcement learning in a virtual environment, various condition simulations before application are completed, thereby eliminating the need for engineers to calibrate online and saving the human resources of the engineers. During the motion control process of the robotic arm, ensuring that its posture does not collide with the casing is crucial (collision learning path). Various posture combinations can be considered, and relatively safe solutions can be selected from them. For this reason, the present disclosure adopts a virtual environment for learning and simulation, using ROS (robot operating system) simulation as an interface, and utilizing the reward mechanism of reinforcement learning to accurately judge whether the robotic arm will experience collision or interference during its movement. This approach can continuously trial, error, and optimize in a virtual environment, allowing the robotic arm to perform tasks more stably and safely during actual operation, thus avoiding collision problems caused by improper posture. It improves the reliability and safety of the present disclosure and provides strong assurance for the efficient operation of the robotic arm.

Additionally, this method requires assembly simulation testing in the virtual environment before application. If it is a structural test and process test of the entire line, the digital twin system will undergo testing first. During control of robotic arm, ROS (robot operating system) will be used for simulation.

The embodiments of the present disclosure provide a method for obtaining position coordinates of a component. The method includes: obtaining a panoramic image corresponding to a component tray through a first camera device arranged at a predetermined position; inputting the panoramic image into a component recognition model to obtain a type and initial position coordinates of the component in the component tray; controlling a robotic arm to move to a target position according to the type and the initial position coordinates of the component, and then obtaining an overall image of the component through a second camera device provided on the robotic arm; and inputting the overall image of the component into a component positioning model to obtain final position coordinates of the component in the component tray. The present disclosure obtains the position coordinates of the component through the camera device, the component recognition model, and the component positioning model, thereby improving the accuracy of position recognition for the component.

Based on the same inventive concept, the embodiment of the present disclosure also provides a device for obtaining position coordinates of a component corresponding to the method for obtaining position coordinates of a component. Since the principle of the device in the embodiment of the present disclosure for solving the problem is similar to the method for obtaining position coordinates of a component above in the embodiment of the present disclosure, the implementation of the device can refer to the implementation of the method, and the repetitive parts will not be reiterated.

Referring to FIG. 4, FIG. 4 illustrates a structural diagram of a device for obtaining position coordinates of a component provided in an embodiment of the present disclosure, and the device includes:
an acquisition module 401, configured for obtaining a panoramic image corresponding to a component tray through a first camera device arranged at a predetermined position, wherein a component to be assembled is placed in the component tray; and
an input module 402, configured for inputting the panoramic image into a component recognition model to obtain a type and initial position coordinates of the component in the component tray.

The acquisition module 401 is further configured for controlling a robotic arm to move to a target position according to the type and the initial position coordinates of the component, and then obtaining an overall image of the component through a second camera device provided on the robotic arm, wherein the overall image of the component includes the overall image of the component to be assembled.

The input module 402 is further configured for inputting the overall image of the component into a component positioning model to obtain final position coordinates of the component in the component tray.

The embodiments of the present disclosure provide a device for obtaining position coordinates of a component. The device can obtain the position coordinates of the component through the camera device, the component recognition model, and the component positioning model, thereby improving the accuracy of position recognition of the component.

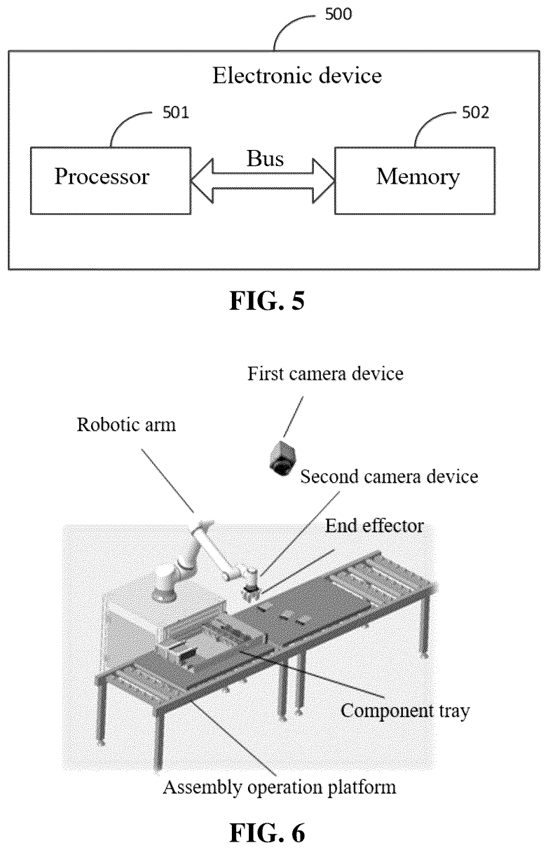

As shown in FIG. 5, the embodiments of the present disclosure provide an electronic device 500, including: a processor 501, a memory 502, and a bus, wherein the memory 502 stores machine-readable instructions executable by the processor 501. When the electronic device operates, the processor 501 communicates with the memory 502 via the bus, and the processor 501 executes the machine-readable instructions to perform the steps of the method for obtaining position coordinates of a component as described above.

Specifically, the memory 502 and the processor 501 mentioned above can be general-purpose memory and processors. No specific limitations are made herein. When the processor 501 runs the computer program stored in the memory 502, it can execute the method for obtaining position coordinates of a component described above.

Corresponding to the method for obtaining position coordinates of a component above, the embodiments of the present disclosure provide a computer-readable storage medium, wherein the computer readable storage medium stores a computer program. When the computer program is executed by the processor, it performs the steps of the method for obtaining position coordinates of a component as described above.

As shown in FIG. 6, the embodiments of the present disclosure provide an equipment assembly system, wherein the system includes a controller, a robotic arm, a first camera device, a second camera device, and an assembly operation platform.

The second camera device is mounted on an upper end of an end effector of the robotic arm, the assembly operation platform is configured for placing a component tray, and a component to be assembled is placed in the component tray.

In the embodiments of the present disclosure, the end effector must have high repeatability and must be stable, and must not damage components and assembly equipment.

The controller is configured to execute the method for obtaining position coordinates of a component to obtain the final position coordinates of the component in the component tray.

The controller is further configured to control the robotic arm to assemble the component according to the final position coordinates.

An equipment assembly system is provided in an embodiment of the present disclosure. The system obtains the position coordinates of the component through the camera device, the component recognition model, and the component positioning model, thereby improving the accuracy of position recognition of the component. Further, the robotic arm is controlled to assemble components according to the final position coordinates, thereby improving assembly efficiency.

It will be clear to those skilled in the field that, for the convenience and brevity of the description, the specific working processes of the systems and apparatus described above can be referred to the corresponding processes in the method embodiments and will not be repeated in the present disclosure. In the several embodiments provided in the present disclosure, it should be understood that the systems, devices, and methods disclosed, can be implemented in other ways. The above-described embodiments of the device are merely schematic. For example, the division of the modules described, which is only a logical functional division, can be divided in another way when actually implemented; and for another example, multiple modules or components can be combined or integrated into another system, or some features can be ignored or not implemented. On another point, the mutual coupling or direct coupling or communication connection shown or discussed herein can be an indirect coupling or communication connection through communication interfaces, devices, or modules, which can be electrical, mechanical, or in other forms.

The modules described as separate components may or may not be physically separate, and the components displayed as modules may or may not be physical units, meaning they can be located in one place or distributed across multiple network units. Some or all of the units can be selected as needed to achieve the objectives of the embodiments of the present disclosure.

Further, each functional unit in each embodiment of the present disclosure can be integrated into a single processing unit, each unit can be physically present separately, or two or more units can be integrated into a unit.

When the functions are implemented as software functional units and sold or used as independent products, they can be stored in a processor-executable, non-volatile, computer-readable storage medium. Based on this understanding, the technical solution of the present disclosure can essentially be embodied in the form of a software product, which contributes to or includes parts in the prior art. The software product is stored in a storage medium and includes multiple instructions for causing a computer device (which can be a personal computer, server, network device, etc.) to execute all or some of the steps of the Information processing methods described in various embodiments of the present disclosure. The aforementioned storage media include: a U disk, a mobile hard disk, a ROM, a RAM, a magnetic disk or optical disk, and other media that can store program codes.

The above are only specific embodiments of the present disclosure, but the scope of protection of the present disclosure is not limited thereto. Any person skilled in the art can easily envisage changes or substitutions within the technical scope disclosed in the present disclosure, which should be encompassed within the scope of protection of the present disclosure. Therefore, the scope of protection of the present disclosure shall be stated to be subject to the scope of protection of the claims.

1. A method for obtaining position coordinates of a component, wherein the method comprises:
obtaining a panoramic image corresponding to a component tray through a first camera device arranged at a predetermined position, wherein a component to be assembled is placed in the component tray;
inputting the panoramic image into a component recognition model to obtain a type and initial position coordinates of the component in the component tray;
controlling a robotic arm to move to a target position according to the type and the initial position coordinates of the component, and then obtaining an overall image of the component through a second camera device provided on the robotic arm, wherein the overall image of the component comprises the overall image of the component to be assembled; and
inputting the overall image of the component into a component positioning model to obtain final position coordinates of the component in the component tray.

2. The method for obtaining the position coordinates of the component according to claim 1, wherein the step of controlling a robotic arm to move to a target position according to the type and the initial position coordinates of the component, and then obtaining an overall image of the component through a second camera device provided on the robotic arm comprises:
determining a shooting height of the second camera device according to the type of the component, wherein the second camera device is mounted on an upper end of an end effector of the robotic arm;
determining a movement path of the robotic arm according to the shooting height, the initial position coordinates, and current position coordinates of the robotic arm; and
controlling the robotic arm to move to the target position according to the movement path, and then obtaining the overall image of the component through the second camera device provided on the robotic arm.

3. The method for obtaining the position coordinates of the component according to claim 2, wherein the step of determining a movement path of the robotic arm according to the shooting height, the initial position coordinates, and current position coordinates of the robotic arm comprises:
determining a sum of a height coordinate value in the initial position coordinates and the shooting height as a target height;
modifying a height coordinate value in the current position coordinates of the robotic arm to the target height to obtain first movement position coordinates;
modifying the height coordinate value in the initial position coordinates to the target height to obtain second movement position coordinates;
inputting the current position coordinates of the robotic arm as a starting point and the first movement position coordinates as an endpoint into a first path planning model to obtain a first movement path;
inputting the first movement position coordinates of the robotic arm as a starting point and the second movement position coordinates as an endpoint into the first path planning model to obtain a second movement path; and
connecting the first movement path and the second movement path to obtain the movement path of the robotic arm.

4. The method for obtaining the position coordinates of the component according to claim 2, wherein the step of determining a movement path of the robotic arm according to the shooting height, the initial position coordinates, and current position coordinates of the robotic arm further comprises:
inputting the shooting height, the initial position coordinates, and the current position coordinates of the robotic arm into a second path planning model to obtain the movement path of the robotic arm, wherein a starting point of the movement path is the current position coordinates of the robotic arm, a sum of a height coordinate value in the initial position coordinates and the shooting height is a height coordinate value of an endpoint in the movement path, and a distance between the endpoint in the movement path and a position corresponding to the initial position coordinates is less than a preset distance.

5. The method for obtaining the position coordinates of the component according to claim 1, wherein the method further comprises:
controlling the robotic arm to move to the final position coordinates and grasp the component;
controlling the robotic arm to move according to preset assembly position coordinates corresponding to the component until the current position coordinates of the robotic arm and the preset assembly position coordinates meet a preset numerical relationship condition, and rotating the second camera device according to a preset assembly shooting angle corresponding to the type of the component;
obtaining an assembly scene image through the rotated second camera device, wherein the assembly scene image comprises a position scene corresponding to the preset assembly position coordinates; and
controlling the robotic arm to assemble the component according to the assembly scene image and the preset assembly position coordinates.

6. The method for obtaining the position coordinates of the component according to claim 1, wherein the component recognition model is trained through following steps:
obtaining a panoramic sample image corresponding to the component tray, and position coordinates and a type corresponding to a first component sample in the component tray; and
using the panoramic sample image as a sample, and using the position coordinates and the type corresponding to the first component sample as labels to perform model training on the component recognition model.

7. The method for obtaining the position coordinates of the component according to claim 1, wherein the method further comprises:
calculating a difference between the final position coordinates and the initial position coordinates of the component;
using, when the difference meets a preset difference condition, the panoramic image as sample data and using the final position coordinates and actual type of the component as labels corresponding to the panoramic image, and correspondingly adding them to a sample dataset; and
updating the component recognition model based on sample data in the sample dataset and corresponding labels, when the number of the sample data in the sample dataset is greater than a preset number, or when a non-updated duration corresponding to the component recognition model is greater than a preset update duration.

8. The method for obtaining the position coordinates of the component according to claim 1, wherein the component positioning model is trained through following steps:
obtaining an overall sample image of the component and position coordinates corresponding to a second component sample in the overall sample image of the component; and
using the overall sample image of the component as a sample, and using the position coordinates corresponding to the second component sample as labels to perform model training on the component positioning model.

9. A device for obtaining position coordinates of a component, wherein the device comprises:
an acquisition module, configured for obtaining a panoramic image corresponding to a component tray through a first camera device arranged at a predetermined position, wherein a component to be assembled is placed in the component tray; and
an input module, configured for inputting the panoramic image into a component recognition model to obtain a type and initial position coordinates of the component in the component tray, wherein
the acquisition module is further configured for controlling a robotic arm to move to a target position according to the type and the initial position coordinates of the component, and then obtaining an overall image of the component through a second camera device provided on the robotic arm, wherein the overall image of the component comprises the overall image of the component to be assembled; and
the input module is further configured for inputting the overall image of the component into a component positioning model to obtain final position coordinates of the component in the component tray.

10. An electronic device, comprising a processor, a storage medium, and a bus, wherein the storage medium stores machine-readable instructions executable by the processor; when the electronic device operates, the processor communicates with the storage medium via the bus, and the processor executes the machine-readable instructions to perform the steps of the method for obtaining the position coordinates of the component according to claim 1.

11. A computer-readable storage medium, wherein the computer-readable storage medium stores a computer program, and when executed by a processor, the computer program performs the steps of the method for obtaining the position coordinates of the component according to claim 1.

12. An equipment assembly system, wherein the system comprises a controller, a robotic arm, a first camera device, a second camera device, and an assembly operation platform, wherein
the second camera device is mounted on an upper end of an end effector of the robotic arm; the assembly operation platform is configured for placing a component tray, and a component to be assembled is placed in the component tray;
the controller is configured to execute the method for obtaining the position coordinates of the component according to claim 1, to obtain the final position coordinates of the component in the component tray; and
the controller is further configured to control the robotic arm to assemble the component according to the final position coordinates.

13. The equipment assembly system according to claim 12, wherein the step of controlling a robotic arm to move to a target position according to the type and the initial position coordinates of the component, and then obtaining an overall image of the component through a second camera device provided on the robotic arm comprises:
determining a shooting height of the second camera device according to the type of the component, wherein the second camera device is mounted on an upper end of an end effector of the robotic arm;
determining a movement path of the robotic arm according to the shooting height, the initial position coordinates, and current position coordinates of the robotic arm; and
controlling the robotic arm to move to the target position according to the movement path, and then obtaining the overall image of the component through the second camera device provided on the robotic arm.

14. The equipment assembly system according to claim 13, wherein the step of determining a movement path of the robotic arm according to the shooting height, the initial position coordinates, and current position coordinates of the robotic arm comprises:
determining a sum of a height coordinate value in the initial position coordinates and the shooting height as a target height;
modifying a height coordinate value in the current position coordinates of the robotic arm to the target height to obtain first movement position coordinates;
modifying the height coordinate value in the initial position coordinates to the target height to obtain second movement position coordinates;
inputting the current position coordinates of the robotic arm as a starting point and the first movement position coordinates as an endpoint into a first path planning model to obtain a first movement path;
inputting the first movement position coordinates of the robotic arm as a starting point and the second movement position coordinates as an endpoint into the first path planning model to obtain a second movement path; and
connecting the first movement path and the second movement path to obtain the movement path of the robotic arm.

15. The equipment assembly system according to claim 13, wherein the step of determining a movement path of the robotic arm according to the shooting height, the initial position coordinates, and current position coordinates of the robotic arm further comprises:
inputting the shooting height, the initial position coordinates, and the current position coordinates of the robotic arm into a second path planning model to obtain the movement path of the robotic arm, wherein a starting point of the movement path is the current position coordinates of the robotic arm, a sum of a height coordinate value in the initial position coordinates and the shooting height is a height coordinate value of an endpoint in the movement path, and a distance between the endpoint in the movement path and a position corresponding to the initial position coordinates is less than a preset distance.

16. The equipment assembly system according to claim 12, wherein the method further comprises:
controlling the robotic arm to move to the final position coordinates and grasp the component;
controlling the robotic arm to move according to preset assembly position coordinates corresponding to the component until the current position coordinates of the robotic arm and the preset assembly position coordinates meet a preset numerical relationship condition, and rotating the second camera device according to a preset assembly shooting angle corresponding to the type of the component;
obtaining an assembly scene image through the rotated second camera device, wherein the assembly scene image comprises a position scene corresponding to the preset assembly position coordinates; and
controlling the robotic arm to assemble the component according to the assembly scene image and the preset assembly position coordinates.

17. The equipment assembly system according to claim 12, wherein the component recognition model is trained through following steps:
obtaining a panoramic sample image corresponding to the component tray, and position coordinates and a type corresponding to a first component sample in the component tray; and
using the panoramic sample image as a sample, and using the position coordinates and the type corresponding to the first component sample as labels to perform model training on the component recognition model.

18. The equipment assembly system according to claim 12, wherein the method further comprises:
calculating a difference between the final position coordinates and the initial position coordinates of the component;
using, when the difference meets a preset difference condition, the panoramic image as sample data and using the final position coordinates and actual type of the component as labels corresponding to the panoramic image, and correspondingly adding them to a sample dataset; and
updating the component recognition model based on sample data in the sample dataset and corresponding labels, when the number of the sample data in the sample dataset is greater than a preset number, or when a non-updated duration corresponding to the component recognition model is greater than a preset update duration.

19. The equipment assembly system according to claim 12, wherein the component positioning model is trained through following steps:
obtaining an overall sample image of the component and position coordinates corresponding to a second component sample in the overall sample image of the component; and
using the overall sample image of the component as a sample, and using the position coordinates corresponding to the second component sample as labels to perform model training on the component positioning model.

20. The electronic device according to claim 10, wherein the step of controlling a robotic arm to move to a target position according to the type and the initial position coordinates of the component, and then obtaining an overall image of the component through a second camera device provided on the robotic arm comprises:
determining a shooting height of the second camera device according to the type of the component, wherein the second camera device is mounted on an upper end of an end effector of the robotic arm;
determining a movement path of the robotic arm according to the shooting height, the initial position coordinates, and current position coordinates of the robotic arm; and
controlling the robotic arm to move to the target position according to the movement path, and then obtaining the overall image of the component through the second camera device provided on the robotic arm.
